(19) United States
(12) Patent Application Publication
(10) Pub. No.: US 2002/0101072 A1
(43) Pub. Date: Aug. 1, 2002

(54) Method of specifying a location on a surface, and an article comprising such a surface

(76) Inventor: Stephen Dominic Infield, Claygate (GB)

Correspondence Address: Henry E. Naylor, Henry E. Naylor & Associates, LLC, 11750A S. Harrell's Ferry Rd, Baton Rouge, LA, 70816, US

(21) Appl. No.: 10/104,893

(22) Filed: Mar. 21, 2002

(30) Foreign Application Priority Data
Jul. 21, 2000 (GB) GB 0017786.5
Apr. 4, 2001 (GB) GB 0108387.2
Jul. 20, 2001 (GB) PCT/GB01/03263

(51) Int. Cl. G09B 29/00

(52) U.S. Cl. 283/34

(57) ABSTRACT

A method of specifying a location on a surface. The invention also relates to an article having a surface on which the location is or can be specified.

### FIELD OF THE INVENTION

The present invention relates to a method of specifying a location on a surface. The invention also relates to an article having a surface on which the location is or can be specified.

### BACKGROUND OF THE INVENTION

A problem in specifying a location on a surface is that various types of coordinates are often used, and the coordinates often are inherently complex and/or relatively inaccurate and/or provide no obvious clue by which to envisage the position of the location.

It is an object of the present invention to provide a method of specifying a location on a surface which at least partly avoids or mitigates one or more of the foregoing and other problems and drawbacks.

### SUMMARY OF THE INVENTION

In accordance with the present invention there is provided a method of specifying a location on the surface of a map or an overlay for a map, comprising dividing the said surface into a plurality of regions which are each identifiable by a respective single digit, wherein the plurality of regions is selected from either (i) six regions or (ii) nine regions, and allocating a respective one of the numbers (i) 1 to 6, or (ii) 1 to 9, to each region whereby each number identifies a respective region including at least part of the location, and dividing each region into a plurality of areas which are each indicated or identified by a respective single digit character

In one aspect, the invention provides a method of specifying a location on a surface, the method being in accordance with claim 1 of the claims which follow this description, and optionally in accordance with one or more of the feature(s) of one or more of the other claims.

In another aspect, the invention provides an article comprising a surface in accordance with the independent claim to an article which follows this description, and optionally in accordance with one or more of the feature(s) of one or more of the other claims.

### BRIEF DESCRIPTION OF THE FIGURES

FIG. 1 shows a page from a map or atlas or a transparent overlay for use with one or more pages from a map or atlas, in accordance with the invention;

FIG. 2 shows some features of another embodiment in accordance with the invention;

FIG. 3 shows some features of another embodiment in accordance with the invention;

FIG. 4 shows a part of the embodiment of any one of FIGS. 1, 2 or 3 wherein a region is divided into a plurality of areas, in accordance with the invention;

FIG. 5 shows another embodiment of FIG. 4;

FIG. 6 shows another embodiment of FIG. 4 or FIG. 5;

FIG. 7 shows another embodiment of FIGS. 4, 5 or 6;

FIG. 8 shows one embodiment of an ikon or sign for use with any embodiment of the invention using a 3×3 array of rectangles. The ikon or sign is also shown in FIG. 1.

### DETAILED DESCRIPTION OF THE INVENTION

In one embodiment of the invention, described by way of non-limitative example, a map (e.g., of a town) is provided on one or more sheets, which may be pages in a book or atlas. There may be an index of features (e.g., streets and/or other landmarks) shown on the map. The or each page of the map may be divided into rectangular spaces, which could be squares in one type of embodiment. Each rectangle may be indicated or denoted by a single respective digit. In one type of embodiment employing six rectangles, which could be in an array of 2 by 3 rectangles or 3 by 2 rectangles, the respective digits may be the numbers 1, 2, 3, 4, 5 and 6. In another type of embodiment employing nine rectangles, suitably in an array of three rectangles by three rectangles, the respective digits may be the numbers 1, 2, 3, 4, 5, 6, 7, 8 and 9. The nine rectangles may be arranged and numbered like the numbered keys on a conventional keypad of a telephone.

An ikon or sign (preferably small relative to the page or an overlay for a page) may be shown on the page(s) of the map or atlas (or overlay) as a guide or reminder to the user of the arrangement of rectangles. If the “keys” on the ikon or sign are numbered in the manner intended for the rectangles of the map or overlay, it may not be necessary to show the numbering of the rectangles on the map or overlay itself (since the numbering would be apparent to the user from the ikon or sign) thereby reducing still further clutter on the map or atlas and improving its clarity.

The digits may be applied (e.g., printed) on the page(s) of the map,or they may be applied on a transparent overlay which may also have the rectangular markings (e.g., squares). If the rectangular markings are on an overlay, there may be no need to provide them (or all of them) on the page(s) of the map. The index of features shown on the map may refer only to the number of the rectangle in which a particular feature appears on the page of the map. Thus, a particular feature can be found on a map by referring to the single digit in the index which identifies the rectangle of the map or overlay in which the feature is located. If the map is a multi-page map, the index would additionally refer to the page of the map on which the feature is shown. An advantage, from the user's viewpoint, is that the map is relatively less cluttered than maps of previous types in which the location of a feature is given in the index for the or each page by more than one digit, usually a combination of letters and numbers (e.g., the so-called “battleship” array).

As a result of the simple mode of indicating locations on a map in accordance with the invention, the user can find the location of a feature on a map or atlas more quickly and with more precision than previously. The convenience of use is enhanced by the reduced clutter on the map or atlas.

In another embodiment for which the location of features on the map can be found with more precision, each rectangle (e.g., square) of the map or overlay is divided into sub-divisions, each of which is or may be denoted or identified by a single digit.

There may be any convenient number of sub-divisions. In one embodiment, there may be nine sub-divisions, and they may be arranged in a three by three array. They may be identified by respective numbers 1, 2, 3, 4, 5, 6, 7, 8, 9. The nine sub-divisions may be arranged and numbered like the numbered keys on a conventional keypad of a telephone. In another embodiment, there may be six sub-divisions. They may be in a two by three array or a three by two array, and identified by respective numbers 1, 2, 3, 4, 5 and 6. In yet another embodiment, there may be four sub-divisions in a two by two array, each of which may be identified by a respective one of the numbers 1, 2, 3, 4. The four sub-divisions may be demarcated by two mutually perpendicular lines forming a cross. The use of subdivisions as just described enables the user to identify the location of a feature on a page of a map with great precision from a simple index of features without cluttering the map or overlay with numbers and letters. Moreover, the user is not burdened with more than three digits for the or each page of the map or overlay.

For even greater precision, the sub-divisions may each be further divided into smaller areas on the map or overlay. There may be any convenient number of smaller areas. For example, there may be nine or six or four smaller areas for each sub-division, and they may each be indicated by a respective number. If there are (e.g.) nine smaller areas, they may be arranged in a three by three array, and each numbered by a respective digit from 1 to 9. Similarly, if there are six smaller areas, which could be in a two by three array or three by two array, the smaller areas may be indicated by a respective single number in the range 1 to 6. If there are four smaller areas, which would preferably be in a two by two array, the smaller areas may each be indicated by a respective one of the numbers 1, 2, 3, 4. The smaller areas may be demarcated by two lines which are mutually perpendicular in the form of a cross. Thus, by way of non-limitative illustration, for the 29th page of a street atlas of a town, a feature indicated in an index by the reference 29 5-5-5- would obviously be in the central rectangle of a 3×3 array of rectangles on page 29, and would also be in the center of that central rectangle if the latter were subdivided into a 3×3 array of sub-rectangles. The final “5” would indicate the center of the central subrectangle if the latter were further divided into 3×3 smaller rectangular areas. Indeed, the user would rapidly learn where, on the page(s) of a map, various combinations of locational indicia would indicate. For example, the reference 15 1-1-1 in the map index would indicate page 15, top left-hand corner. An experienced user would probably be able to find the location of a feature on a map without the need to refer to any actual or notional lines and/or other markings (e.g., colors and/or hues) demarcating the smallest areas.

The invention is now described by way of non-limitative examples and with reference to the accompanying diagrammatic figures.

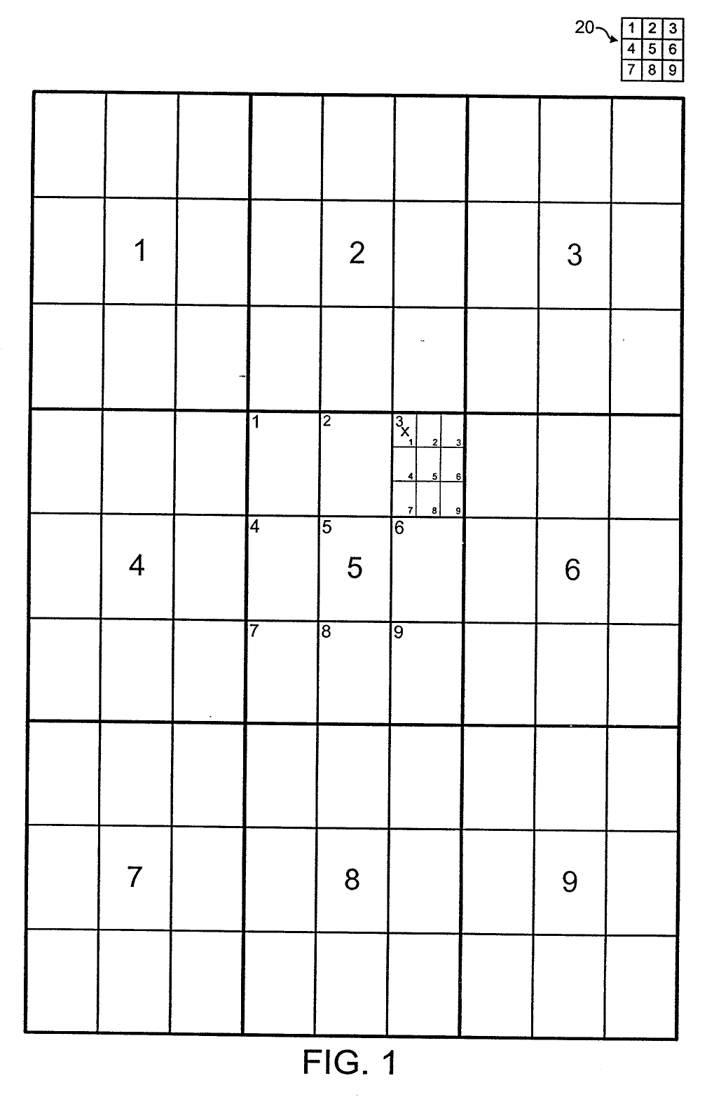

Referring first to FIG. 1, there is shown a page from a map or atlas, or alternatively, a single sheet transparent overlay for use with a map or atlas. The page or overlay is divided into nine rectangular regions in a three by three array. The rectangular regions are each numbered with a respective number 1 to 9. It can be appreciated that the location of a feature on the page can be identified by referring to the single digit number indicating the rectangle around the feature. Thus, the number 7 refers to features in the bottom left rectangle of the page or overlay.

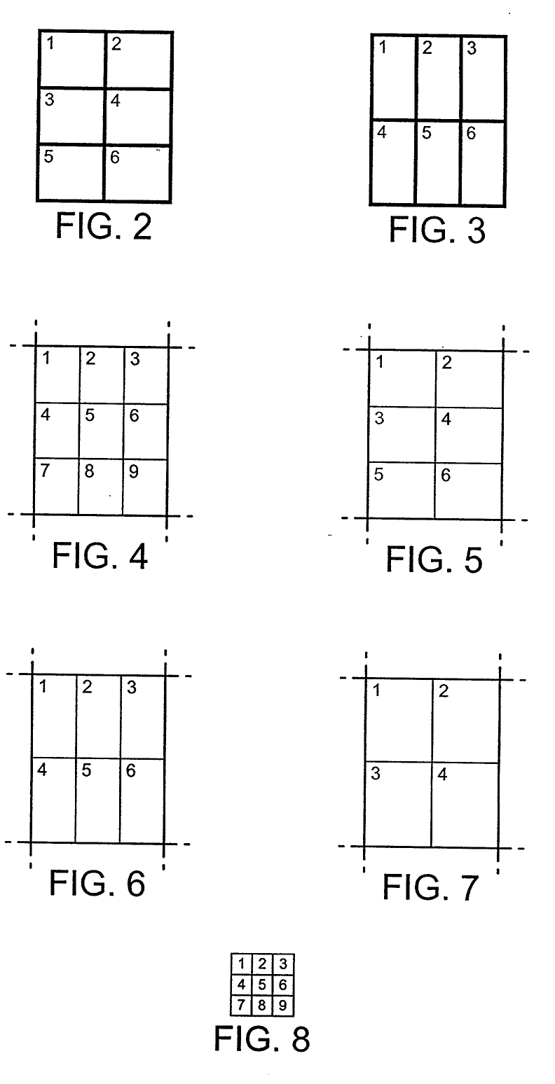

FIG. 2 is similar to FIG. 1 except that the page or overlay is divided into six rectangular regions in a two by three array. The rectangular regions are numbered 1 to 6. In FIG. 2, as shown, number 4 indicates the rectangle at the center-right of the page or overlay.

FIG. 3 is similar to FIG. 2 in that the page or overlay is divided into six rectangular regions. However, the six regions are in a three by two array, and in this embodiment, the single digit “4” indicates the rectangular region at the bottom left of the page or overlay.

FIG. 4 shows, to a larger scale, one rectangular area of the page(s) or overlay(s) of any of FIGS. 1, 2 or 3. The rectangular region is subdivided into nine rectangular areas in a three by three array. Each rectangular area is identified by a respective single digit numbered from 1 to 9. Thus, area 3, as depicted in FIG. 4, indicates the top right rectangular area within its larger rectangular region. Thus if the rectangular region were rectangle 2 in FIG. 2, the rectangular area 3 would be at the top right corner of the map or overlay, without significant or substantial clutter on the map or overlay. Similarly, FIGS. 5, 6 and 7 show other arrays for rectangular areas which could be used in the embodiments of FIGS. 1, 2 and 3.

FIG. 8 shows one type of small ikon or sign that may be provided on (e.g.) FIG. 1 to indicate the numbers allocated to the respective numbered rectangular regions 1 to 9. The ikon has the layout of a standard telephone keypad. It maybe used to obviate the need to provide numbers in or on the rectangular regions whereby the map appears less cluttered, and its clarity is correspondingly enhanced. The type of ikon or sign employed would correspond with the type of array on the page(s) of the map or overlay.

In another type of embodiment (not shown), the rectangular areas of FIGS. 4, 5 and 6 can be further divided into zones in the same way as is shown for the subdivisions into areas of the “large” rectangular regions of FIGS. 1, 2 and 3. This further sub-division into zones provides great precision of identification of locations on the page of the map or overlay without necessarily cluttering the page or overlay. In many instances, an experienced user would find it adequate to have the single digit references for each zone resulting from the further division of the rectangular areas quoted in an index of features without the need to show the lines and/or other means (e.g., colors and/or hues) demarcating the zones or their respective numbers. The user would quickly appreciate that (for example) in a map using, e.g., nine by nine arrays of rectangular regions, areas and zones, the index reference 13 5-9-1 would indicate page 13, region 5 (the central rectangle 5), bottom right area (“sub-rectangle 9”), top left zone (of the sub-rectangular area 9), giving greater precision when only the rectangular regions and rectangular areas are indicated on the page(s) or overlay, or even when only the regions are demarcated or indicated.

The invention may also comprise an index listing features indicated on the map or atlas together with a map reference indicating the rectangular regions, areas, zones (and even finer divisions such as sub-zones, etc). If the map or atlas is a multi-page work, the index may also comprise a page reference for each feature.

The rectangular regions and/or overlays and/or zones may be separately depicted on two overlays, rather than on a single overlay, and/or in part on the map or atlas. For example, the rectangular regions of FIGS. 1, 2 and/or 3 could be shown on the page(s) of a map or atlas. The finer sub-divisions (e.g., as shown and/or described with reference to FIGS. 4, 5, 6 and 7) could be on one or more overlays.

Reference is now made again to FIG. 1 wherein it will be observed that (by way of non-limitative illustration) the rectangular regions 1 to 9 are each divided into nine rectangular areas in a 3×3 array. The nine areas are each numbered respectively 1 to 9 (i.e., in an arrangement like that used on a conventional telephone keypad). By way of a non-limiting illustration, area 5 of the nine areas is shown sub-divided into nine rectangular zones. The nine zones are in a 3×3 array, and each zone is numbered respectively 1 to 9 (i.e., as in a conventional telephone keypad array). The location of the point “X” shown in FIG. 1 would be indicated in an index by the references 5-3-1. The user would quickly become accustomed to the telephone keypad layout, and would easily be able to identify the location of a point on a map (or overlay) from the numbers allocated in the index to the region and the area (and the zone, if further accuracy were required). In addition to the ease of use, it is worthwhile considering that accuracy or precision is a feature of the system of the invention.

Often, ease of use of maps, atlases, etc. is compromised for the sake of accuracy, but in the case of the present invention, the two (i.e., ease of use and accuracy) are available together. By way of example referring to FIG. 1, in terms of accuracy, each rectangular region represents one ninth of the area of the page or overlay. Each rectangular area represents 1/81 of the area of the map or overlay, and probably provides a degree of locational precision which would be adequate for most purposes (and more accurate than most traditional “battleship” type map indexing systems used in, e.g., street atlases). Each rectangular zone represents 1/729 of the area of a map page or of an overlay, virtually pinpointing the location of a feature sought by the user, yet employing only three indexing digits (e.g., 5-3-1 for “X” in FIG. 1). Such accuracy with attendant facility and convenience for the map's user has not previously been available for maps, atlases and overlays therefor.

A small keypad ikon 20 is shown in FIG. 1 to indicate to the user the type of array and numbering system used for the array, obviating the necessity to number at least the regions 1 to 9, thereby reducing clutter on the page(s) of the map and/or overlay. The user will, after a short period of experience, become so accustomed to the array and its numbering system that no numbering might be required or needed on any of the rectangles, whereby the clarity of the map (or overlay) would or could be further enhanced.

In a further embodiment (not shown), the lines demarcating the large rectangles may be abbreviated or truncated to short lines or projections at or on the margin or edge of the map and/or overlay and/or in (and/or on) a frame around the map or overlay. The experienced user would be able to find locations by mentally projecting or extending the abbreviated lines from the margin and/or edge so as to form the rectangles that they would in fact define if they were provided in full.

Where sets of parallel lines are employed to define the various regions, areas and zones, the lines may be of different types for the regions, areas and zones. For example, the lines for the regions may be relatively bold, and those for the areas and zones may each be relatively finer. Alternatively, or in addition, the regions, areas and zones may be defined by different colors and/or shadings. Thus, in one embodiment, the division(s) of the page(s) of a map or atlas may be provided at least in part by checkerboard-type shading(s) and/or coloring(s) either alone and/or supplemented in part by lines (e.g., parallel lines), as described above, or as stated above, not demarcated at all or in full.

Where one or more overlays are employed, the map or atlas may have indicia to ensure that the overlay(s) is or are accurately aligned or positioned on the or each page.

Features of the invention as disclosed, defined or claimed herein which are shown and/or disclosed in connection with one embodiment may be used in combination(s) with other feature(s) shown and/or described while remaining within the scope of the invention.

1. A method of specifying a location on the surface of a map or an overlay for a map, comprising dividing the said surface into a plurality of regions which are each identifiable by a respective single digit, wherein the plurality of regions is selected from either (i) six regions or (ii) nine regions, and allocating a respective one of the numbers (i) 1 to 6, or (ii) 1 to 9, to each region whereby each number identifies a respective region including at least part of the location, and dividing each region into a plurality of areas which are each indicated or identified by a respective single digit character

2. The method of claim 1 comprising employing an index of features on a map whose locations are each indicated by a combination of characters for the regions, areas and any zones of areas within which they lie on the surface of the map or on the overlay when the overlay is overlain on the surface of the map

3. An article comprising the surface of a map or the surface of an overlay for a map divided into a plurality of regions which are each indicated by a respective single digit number, wherein the plurality consists of either (i) six, or (ii) nine, regions which are each identified by a respective single digit number selected from (i) 1 to 6, or (ii) 1 to 9, and wherein each region is divided into a plurality of areas which are each indicated or identified by a respective single digit character

4. An article as in claim 3 wherein the regions are polygonal

5. An article as in claim 3 wherein the regions are quadrilateral, e.g., rectangular (e.g., square)

6. An article as in claim 3 wherein the said areas are each quadrilateral, e.g., rectangular (e.g., square)

7. An article as in claim 3 wherein there are (a) four, (b) six or (c) nine areas each indicated or identified by a respective number selected respectively from (a) 1 to 4, (b) 1 to 6 or (c) 1 to 9

8. An article as in claim 3 wherein each area is divided into a plurality of zones which are each indicated or identified by a respective single digit character

9. An article as in claim 8 wherein each of the said zones is quadrilateral, e.g., rectangular (e.g., square)

10. An article as in claim 8 wherein the said plurality is selected from (1) four, (2) six or (3) nine, and each zone of the plurality is indicated or identified by a respective number selected respectively from (1) 1 to 4, (2) 1 to 6, or (3) 1 to 9

11. An article as in claim 3 wherein one or more of the regions, areas and any zones of areas is/are demarcated by one or more of the following: sets of lines(e.g., parallel lines); different and/or varying colors and/or hues; different intensities of color(s) and/or shading(s) (e.g., as on a checkerboard)

12. A combination comprising an article as in claim 3 and an index of features on a map whose locations are each indicated by a combination of characters for the regions, areas and any zones of areas (if indicated) within which they lie on the surface of the map or the overlay when the overlay is overlain on the surface of the map.
